(19) United States
(12) Patent Application Publication
(10) Pub. No.: US 2020/0169567 A1
(43) Pub. Date: May 28, 2020

(54) MEDIA COLLABORATION APPLICATION WITH REDACTION BASED ON USER SECURITY CLEARANCE

(71) Applicant: Lenovo Enterprise Solutions (Singapore) Pte. Ltd., Singapore (SG)

(72) Inventors: Charles Christian Queen, Apex, NC (US); Fred Allison Bower, III, Durham, NC (US); David Bryan Roberts, Newcastle, ME (US)

(21) Appl. No.: 16/201,521

(22) Filed: Nov. 27, 2018

(51) Int. Cl. H04L 29/06; G06F 21/62

(52) U.S. Cl. CPC H04L 63/105; G06F 21/6218; H04L 63/08

(57) ABSTRACT

A computer-implemented method, as well as a computer program product and apparatus, provide for authenticating a plurality of authorized users requesting access to a media object, wherein the media object includes a plurality of media sub-elements, each media sub-element delimiting specific content of the media object. For each of the plurality of sub-elements, a classification level associated with the media sub-element is identified. A security clearance is obtained for each of the plurality of authorized users. For each of the authorized users, output is provided that is formed from the media object with redaction of each sub-element associated with a classification level that prevents access using the security clearance of the authorized user.

### BACKGROUND

The present disclosure relates to electronic media collaboration systems that allow multiple users to simultaneously review and edit a media object, such as an electronic document.

### BACKGROUND OF THE RELATED ART

An electronic media collaboration system allows users to share an application or a portion of their display with participants or attendees located in remote locations. The presenter of the media may select other participants and grant them authorization to the access the media. Furthermore, the presenter may grant individual participants the same or different privilege levels or roles, such as full editing privileges, comment and suggestion privileges, and view only privileges. Each authorized participant may then use their own device to log in to the electronic media collaboration system and interact with the media and with other authorized participants to the extent consistent with their particular privilege level or role. Using their own device, each authorized participant is typically able to see the changes and suggestions made by other participants, and may further interact with the media regarding those changes and suggestions. Accordingly, the goal of preparing media in a collaboration system is to efficiently develop the media with input from all authorized participants regardless of their location.

### BRIEF SUMMARY

One embodiment provides a computer program product comprising non-transitory computer readable storage media having program instructions embodied therewith. The program instructions are executable by a processing unit to authenticate a plurality of users requesting access to a media object, wherein the media object includes a plurality of media sub-elements, each media sub-element delimiting specific content of the media object. The program instructions are further executable by the processing unit to identify, for each of the plurality of sub-elements, a classification level associated with the media sub-element and to obtain, for each of the plurality of authenticated users, a security clearance. The program instructions are still further executable by the processing unit to provide, for each of the authenticated users, output formed from the media object with redaction of each sub-element associated with a classification level that prevents access using the security clearance of the authenticated user.

Another embodiment provides a computer implemented method comprising authenticating a plurality of users requesting access to a media object, wherein the media object includes a plurality of media sub-elements, each media sub-element delimiting specific content of the media object. The method further comprises identifying, for each of the plurality of sub-elements, a classification level associated with the media sub-element, and obtaining, for each of the plurality of authenticated users, a security clearance. The method still further comprises providing, for each of the authenticated users, output formed from the media object with redaction of each sub-element associated with a classification level that prevents access using the security clearance of the authenticated user.

Yet another embodiment provides an apparatus comprising at least one storage device for storing processor-executable program instructions and a processing unit including at least one processor for executing the program instructions. The processing unit is able to execute the program instructions to authenticate a plurality of users requesting access to a media object, wherein the media object includes a plurality of media sub-elements, each media sub-element delimiting specific content of the media object. The processing unit is able to further execute the program instructions to identify, for each of the plurality of sub-elements, a classification level associated with the media sub-element, and obtain, for each of the plurality of authenticated users, a security clearance. The processing unit is able to still further execute the program instructions to provide, for each of the authenticated users, output formed from the media object with redaction of each sub-element associated with a classification level that prevents access using the security clearance of the authenticated user.

### BRIEF DESCRIPTION OF THE SEVERAL VIEWS OF THE DRAWINGS

FIG. 1 is a diagram of an electronic media collaboration system having multiple participant devices.

FIG. 2 is a diagram of one participant computer in communication with a media collaboration management application running on a server or in the cloud.

FIG. 3 is a diagram of a graphical user interface of an electronic media collaboration application displaying a media file on one of the participant devices.

FIG. 4A is a diagram of a graphical user interface displaying the media object of FIG. 3 after two of the sub-elements have been redacted by exclusion.

FIG. 4B is a diagram of a graphical user interface displaying the media object of FIG. 3 after two of the sub-elements have been redacted by obscuring from view.

FIG. 5 is a flowchart of a method for receiving user input into a media collaboration management application.

FIG. 6 is a flowchart of a method for generating media output to an individual authorized user's client computer with automatic redaction of sub-elements for which the authorized user does not have a sufficient security clearance.

FIG. 7 is a diagram of a computer that is representative of an application server or participant device.

### DETAILED DESCRIPTION

One embodiment provides a computer program product comprising non-transitory computer readable storage media having program instructions embodied therewith. The program instructions are executable by a processing unit to authenticate a plurality of users requesting access to a media object, wherein the media object includes a plurality of media sub-elements, each media sub-element delimiting specific content of the media object. The program instructions are further executable by the processing unit to identify, for each of the plurality of sub-elements, a classification level associated with the media sub-element and to obtain, for each of the plurality of authenticated users, a security clearance. The program instructions are still further executable by the processing unit to provide, for each of the authenticated users, output formed from the media object with redaction of each sub-element associated with a classification level that prevents access using the security clearance of the authenticated user.

In various implementations, the computer program product may be referred to as a collaboration application that forms a collaborative working environment. Optionally, the computer program product may facilitate the plurality of users engaging in real-time collaborative editing of the media object. Alternatively, the computer program product may facilitate the plurality of users engaging in version control of the media object.

The program instructions may be further executable by the processing unit to accept input from a media presenter, such as one of the plurality of users, which sets up the media object for collaboration. The input may identify the media object, establish a media collaboration session for the media object, designate one or more users that are authorized to participate in the media collaboration session, and assign a role to each of the plurality of users. For example, the media object may be identified by a file name and a location within a directory system. Optionally, establishing a media collaboration session for the media object may include the establishment of various collaboration parameters, such as a time frame or duration for the collaboration and the scope of the collaboration. Users that are authorized to participate in the media collaboration session may be identified by entering a unique email address, username or other identifying information for each person that should be allowed access to the media collaboration session, or may be identified by entering a unique group name that has been previous associated with the identifying information of each person that should be allowed access to the media collaboration session. For example, a group could be a company department or a cross-functional project team, with each individual member of the department or team being identified in association with the name of the group.

In one embodiment, the role assigned to each of the plurality of users is independently selected from: a first role allowing the user to view, comment on, and edit sub-elements of the media object except for sub-elements that are subject to redaction for the user; a second role allowing the user to view and comment on, but not edit, sub-elements of the media object except for sub-elements that are subject to redaction for the user; and a third role allowing the user to view, but not comment on or edit, sub-elements of the media object except for sub-elements that are subject to redaction for the user. Any number of roles may be created with different allowed capabilities within the collaboration session or relative to the media object.

The role assigned to an individual user may differ among multiple media objects depending the discretion of the media presenter of the particular media object. For example, the media presenter may assigned roles with due consideration to the user's job function or title, the user's affiliation with a particular company or department, or the user's membership in a taskforce or workgroup. However, for any given media object, a media presenter designates one or more authorized users and may assign a role to each authorized user. Each role may define what actions an authorized participant may take with respect to the given media object.

However, previous collaboration systems applied these user roles against an entire media object and the assignment of a user role to an authorized user would not prevent the authorized participant from viewing the entire media object. In a previous collaboration system, if the media presenter desired to prevent an individual user from viewing any given portion of the media object, then the media presenter would typically either avoid designating the individual as an authorized user or omit the given portion from the media object. According to embodiments described herein, the designation of classification levels associated with each sub-element of the media object and the assignment of security clearances to each authorized user facilitates greater inclusion of sub-elements within the media object and greater inclusion of authorized users in the collaboration session. According to various embodiments described herein, the security clearance of each individual authorized user and the classification level assigned to each sub-element will determine what sub-elements of the media object are accessible and provided to the individual authorized user. Each individual authorized user may then receive and view a customized set of the sub-elements of the media object according to the security clearance of the individual authorized user.

In one implementation, each of the plurality of sub-elements may be independently selected from a text element, an image, a video clip, an audio segment, and a hyperlink. Other types of sub-elements may also be included in the media object. Furthermore, the plurality of sub-elements may include a plurality of text elements, wherein each text element may be independently selected from a title, header, page, section, paragraph, sentence, name, address, number, caption, and footnote. Accordingly, the sub-elements may include different types of media and different amounts of media. It is up to the media presenter or other authorized users participating in the collaboration to define the scope of each sub-element, and associate a classification level with each sub-element. Optionally, a sub-element may default to a particular classification level, such a lowest classification level that is accessible to all authorized users. However, a user that is entering information or data into a sub-element of the media object may associate a higher classification level with the sub-element, such that only those authorized users having a suitable security clearance will be granted access to the sub-element. For example, if the media object is a quarterly report to shareholders of a corporation and the authorized users include specific corporate employees, a vice-president of sales may have a security clearance that provides her with fully viewing, commenting and editing of the sales-related sub-elements of the quarterly report, but may also deny her access to even view an announcement of key personnel changes or the pre-release corporate earnings-per-share data.

The security classification level that is assigned to each sub-element may, without limitation, have a format selected from a classification number, a classification name, and an alphanumeric string of characters. Optionally, the classification level associated with each media sub-element is stored as metadata.

The security clearance that is assigned to each of the plurality of authenticated users may have a format that is the same or different than the format of the security classification level. Embodiments of the electronic media collaboration application may access a user list or database that, for each of a plurality of individual users, includes a user identification and a security clearance level associated with each user identification. The user identification may be the user's given name, a username, an employee identification number, other manner of identification. Furthermore, the security clearance level that is associated with each user identification may take any format, such as a security level number, a security level name, or an alphanumeric string of characters. Preferably, the security clearance level has a format similar to the security classification level in order to facilitate comparison and a determination whether the security clearance level of a user is sufficient to gain access to a sub-element that has been assigned a particular security classification level.

Where the formats of the classification levels and the security clearances are not directly comparable, it may be desirable to have a table with entries or records that identify those security clearances that are allowed to access sub-elements associated with certain security classifications levels. For example, a table may have a plurality of records, where each record is provided on a single row of the table. Furthermore, the table may have multiple columns, such that the first column of each record may identify a security clearance and a second column of each record may identify the security classification levels that may be accessed by a user having the security clearance in the first column of the same record. Accordingly, the security clearance assigned to an individual authorized user may be used to determine which sub-elements may be accessed by the individual authorized user during the collaboration session. The security clearance of each user is preferably obtained from a secure remote node and is maintained by a system administrator, such that a typical individual user cannot change their own security clearance or the security clearance of another user.

Redaction of a sub-element in the output provided to a given user may include excluding the sub-element or obscuring the sub-element from view. For example, excluding the sub-element may leave a blank area of the output in the user's graphical user interface or may involve reformatting the remaining sub-elements of the media object as if the excluded sub-element was not part of the media object. Accordingly, one embodiment of the computer program product includes program instructions executable by the processing unit to provide, for each of the authenticated users, output formed from the media object excluding each sub-element associated with a classification level that prevents access using the security clearance of the authenticated user. In certain examples of obscuring the sub-element from view, the sub-element may be blacked-out, replaced with “X”s, distorted beyond recognition, or involve some other visual effect that illustrates to the user that some information has been redacted. Accordingly, another embodiment of the computer program product includes program instructions executable by the processing unit to provide, for each of the authenticated users, output formed from the media object with each sub-element associated with a classification level that prevents access using the security clearance of the authenticated user being obscured from view.

In one option, the program instructions may be further executable by the processing unit to notify the media presenter that one or more of the authorized users do not have sufficient security clearance to view a particular sub-element of the media object. The notification to the media presenter may include identification of the authorized user and identification of the sub-element(s) that the authorized user is not allowed to access. In a further option, the program instructions may be further executable by the processing unit to automatically mute any audio signal to a given participant regarding the given sub-element in response to the given participant having insufficient security clearance for the classification level of the sub-element. Alternatively, the program instructions may be further executable by the processing unit to dismiss a given authorized user from the media collaboration session prior to the media collaboration application displaying the sub-element to the given authorized user.

Another embodiment provides a computer implemented method comprising authenticating a plurality of users requesting access to a media object, wherein the media object includes a plurality of media sub-elements, each media sub-element delimiting specific content of the media object. The method further comprises identifying, for each of the plurality of sub-elements, a classification level associated with the media sub-element, and obtaining, for each of the plurality of authenticated users, a security clearance. The method still further comprises providing, for each of the authenticated users, output formed from the media object with redaction of each sub-element associated with a classification level that prevents access using the security clearance of the authenticated user. It should be recognized that the foregoing computer implemented method may include any one or more aspects of the computer program product described herein. Accordingly, a separate description of the computer program product will not be duplicated in the context of a computer implemented method.

Yet another embodiment provides an apparatus comprising at least one storage device for storing processor-executable program instructions and a processing unit including at least one processor for executing the program instructions. The processing unit is able to execute the program instructions to authenticate a plurality of users requesting access to a media object, wherein the media object includes a plurality of media sub-elements, each media sub-element delimiting specific content of the media object. The processing unit is able to further execute the program instructions to identify, for each of the plurality of sub-elements, a classification level associated with the media sub-element, and obtain, for each of the plurality of authenticated users, a security clearance. The processing unit is able to still further execute the program instructions to provide, for each of the authenticated users, output formed from the media object with redaction of each sub-element associated with a classification level that prevents access using the security clearance of the authenticated user. It should be recognized that the foregoing apparatus may include any one or more aspects of the computer program product described herein. Accordingly, a separate description of the computer program product will not be duplicated in the context of an apparatus.

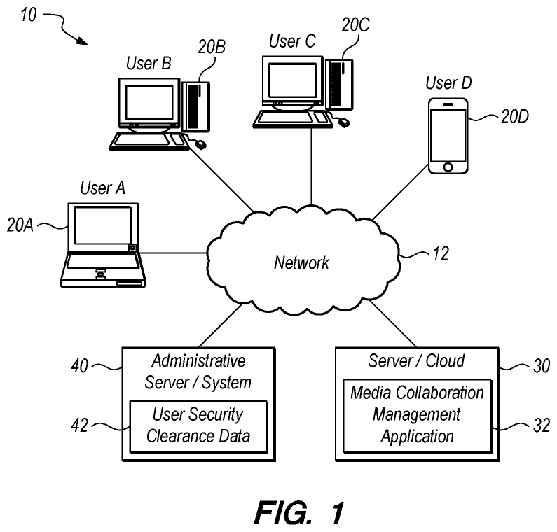

FIG. 1 is a diagram of an electronic media collaboration system 10 having multiple user devices or client devices 20A-D. Each of the client devices 20A-D are able to communicate over a network 12 with a server or cloud 30, which runs a media collaboration application 32. The system 10 further includes an optional administrative server or system 40 that stores user security clearance data 42.

Each of the client devices 20A-D may be considered to be a computing device regardless of the form factor, such as the notebook computer 20A, the desktop or tower computers 20B-C, and the mobile communication device 20D. Furthermore, the server or cloud 30 may be one or more servers and the administrative server or system 40 may also be one or more servers.

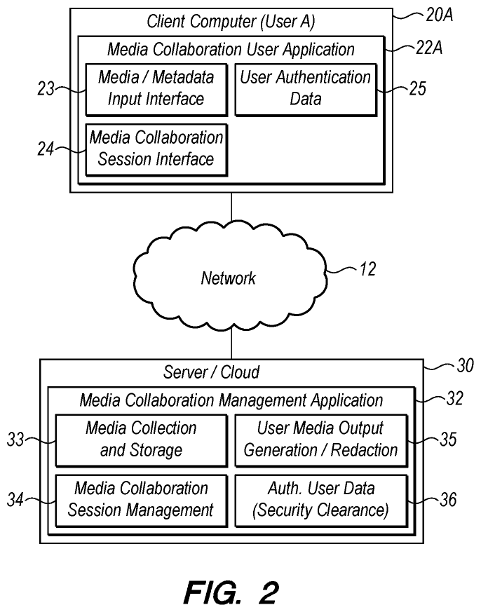

FIG. 2 is a diagram of one client computer 20A in communication over the network 12 with the server or cloud 30. A media collaboration management application 32 is executable on the server or cloud 30 for managing media collaboration among multiple client computers. A media collaboration user application 22A is executable on the client computer 20A for interfacing with the media collaboration management application 32 is executable on the server or cloud 30.

The media collaboration management application 32 includes program instructions that are executable by a processing unit of the server or cloud 30, which may have a single processor or include multiple processors. The program instructions may, without limitation, be organized in modules for performing one or more tasks that are functionally related. For example, the media collaboration management application 32 is shown in one embodiment including a media collection and storage module 33, a media collaboration session management module 34, a user media output generation and redaction module 35, and authorized user data 36 which may include a security clearance for each user. The media collection and storage module 33 may include program instructions for collecting and storing media objects that have been submitted to the media collaboration management application. The media collaboration session management module 34 may include program instructions for managing a media collaboration session to enable multiple authorized users to collaborate with regarding to a particular media object. The authorized user data 36 may include program instructions for authenticating each user or client computer that is attempting access to a media object and determine whether the authenticated user is authorized to access the media object. Furthermore, the authorized user data 36 may include, perhaps only temporarily, security clearance data for each authorized user. The user media output generation and redaction module 35 may include program instructions for generating media output to each authorized user. The media output to each authorized user may include redaction of one or more given sub-elements of the media object if the security clearance assigned to the authorized user does not authorize access to the classification level of the one or more given sub-elements.

The media collaboration user application 22A includes program instructions that are executable by a processing unit of the client computer 20A, which may have a single processor or include multiple processors. The program instructions may, without limitation, be organized in modules for performing one or more tasks that are functionally related. For example, the media collaboration user application 22A is shown in one embodiment including a media and metadata input interface 23, a media collaboration session interface 24, and user authentication data 25. The media and metadata input interface 23 may include program instructions for producing a user interface that allows a user to input media and metadata to the server or cloud 30. For example, the user input may include an entire media object, one or more sub-elements of a media object, and metadata such as a classification level for one or more sub-elements. The media collaboration session interface 24 may include program instructions for producing a user interface that allows a user to participate in a media collaboration session. For example, the user interface may display visual aspects of the media object and accept comments, revisions and new submissions to the media object. The user authentication data 25 may include any information necessary to authenticate the user to the media collaboration management application 32. Authentication information may include, without limitation, a username and password, biometric input, or a digital certificate.

In a media collaboration session where multiple authorized users each have a client computer interfacing with the media collaboration management application 32, the media collaboration session interface 24 of the individual user's client computer may display a custom-generated version of the media object as a function of the user's security clearance relative to the classification levels of the sub-elements in the media object. Furthermore, various types of user input, such as comments, revisions and additional sub-elements, are submitted to the media collaboration management application 32 and subsequently reflected in the media output to the client computers of the other authorized users participating in the media collaboration session. If the plurality of authorized users are engaging in real-time collaborative editing of the media object, then the media collaboration management application 32 will immediately update the interface of each authorized user to reflect input received from any of the authorized users.

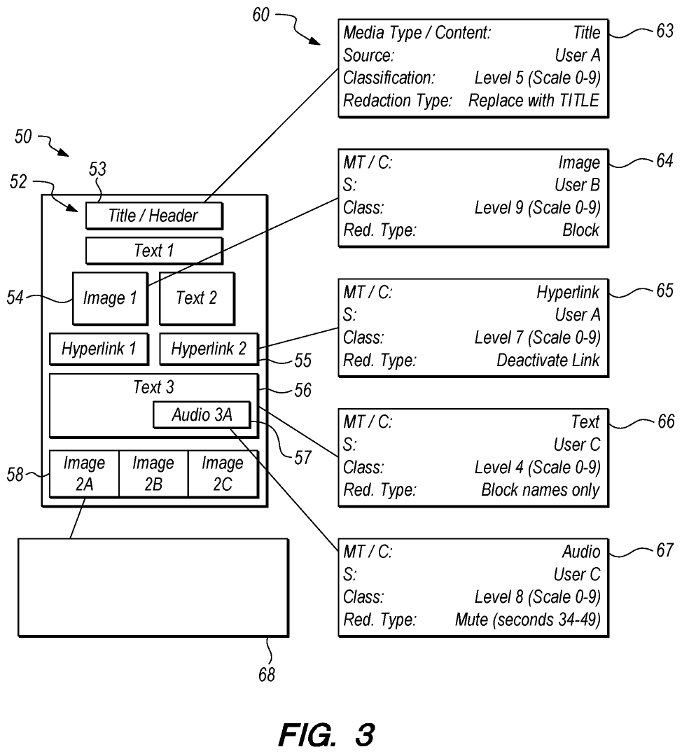

FIG. 3 is a diagram of a graphical user interface 50 generated by the media collaboration management application 30 (shown in FIG. 2) that is provided to, and displayed by, a client computer. The graphical user interface 50 is representative of a media object that is the subject of a media collaboration session. For the purpose of illustration, FIG. 3 further includes examples of metadata 60 that may be associated with one or more sub-elements of the media object. The metadata 60 would typically not be displayed along with the media object, but is stored along with the media object and used by the media collaboration management application 30 when generating output of the media object to the graphical user interface 50 of the client computer for each individual user.

The media object 52 displayed by the graphical user interface 50 includes a plurality of sub-elements, such as the “Title/Header” 53, “Image 1” 54, “Hyperlink 2” 55, “Text 3” 56, “Audio 3A” 57, “Image 2A” 58, and the other sub-elements shown. The media object 52 may be displayed including various content and applying various formatting and configuration parameters input by the authorized users.

The metadata 60 is shown for certain of the sub-elements of the media object 52. The sub-element “Title/Header” 53 is associated with metadata 63, which identifies the media type or content as being a “Title”, the source as being “User A”, the classification level as being “Level 5” on a scale of 0 (low) to 9 (high), and the redaction type as being “Replace with TITLE”. According, the media collaboration management application will generate output to the client computer of an authorized user that includes that actual title of the media object if the authorized user has a security clearance that is 5 or greater and will redact the actual title in favor of the generic text “TITLE” if the authorized user has a security clearance that is less than 5. The metadata 64-68 may be used by the media collaboration management application in a similar manner for different media type and content (MT/C), different sources (S), different classification levels (Class.), and different redaction types (Red. Type).

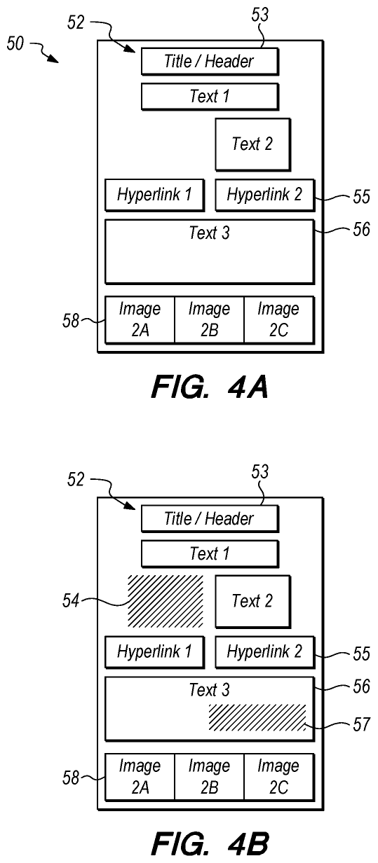

FIG. 4A is a diagram of the graphical user interface 50 displaying the media object 52 of FIG. 3 after two of the sub-elements have been redacted by exclusion. Specifically, if an authorized user had a classification level of “7”, then the sub-element “Image 1” 54 and the sub-element “Audio 3A” 57 may be redacted from the output provided to the authorized user's client computer. FIG. 4A illustrates a possible appearance of the media object 52 if the two redacted sub-elements are excluded. While FIG. 4A does not show any reformatting of the remaining sub-elements, embodiments may reformat the sub-elements provided as if the redacted sub-elements were not part of the media object.

FIG. 4B is a diagram of a graphical user interface displaying the media object of FIG. 3 after two of the sub-elements have been redacted by obscuring from view. Similar to FIG. 4A, the sub-element “Image 1” 54 and the sub-element “Audio 3A” 57 have been redacted from the output provided to the authorized user's client computer. However, FIG. 4B illustrates a possible appearance of the media object 52 if the two redacted sub-elements 54, 57 are obscured from view. It is possible to obscure a sub-element from view if various manners, but are illustrated as being covered or replaced with cross-hatching. Alternative manners of obscuring a sub-element include blacking out the area, distorting the content of the sub-element, or replacing the sub-element with a series of repeated or random text characters. Optionally, the cross-hatching or other manner of obscuring may extend over the same size and shape of area in the user interface as would have been used to display the sub-element if the sub-element not been redacted. In this manner, an authorized user may be denied access to the content of the sub-element while also being given an indication that they have been denied access to some content.

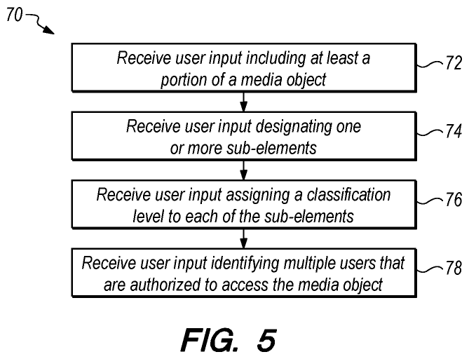

FIG. 5 is a flowchart of a method 70 for receiving user input into a media collaboration management application. In step 72, the media collaboration management application receives user input including at least a portion of a media object. The user input may be the start of a new media object or may add to an existing media object. For example, the user input may include one or more sub-elements. In step 74, the media collaboration management application receives user input designating one or more sub-elements within the media object. Optionally, the one or more sub-elements that are designated may be media content that is being newly added to the media object or media content that was already part of the media object. In step 76, the media collaboration management application receives user input assigning a classification level to each of the sub-elements that should have restricted access. Preferably, media content will be assigned a classification level prior to making the media content accessible to other authorized users. In order to avoid accidental disclosure of a sub-element to an authorized user having an insufficient security clearance, it is preferable to require that assignment of a classification level to each sub-element prior to sharing the media content with other users. In step 78, the media collaboration management application receives user input identifying multiple users that are authorized to access the media object. Optionally, the authorized users may be identified by their name, a username or an email address. The user that determines which users are authorized to access the media object may be referred to as the media presenter. Furthermore, the media presenter may be responsible for providing additional details about a media collaboration session, such as the start time and duration of a media collaboration session.

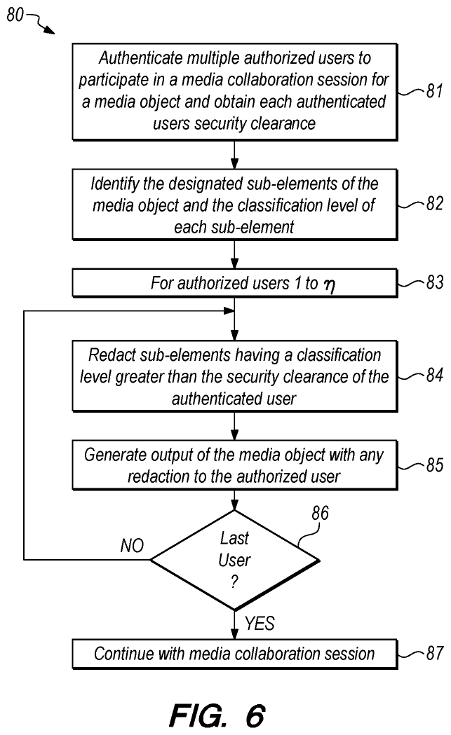

FIG. 6 is a flowchart of a method 80 for generating media output to an individual authorized user's client computer with automatic redaction of any sub-elements for which the authorized user does not have a sufficient security clearance. In step 81, the media collaboration management application may authenticate multiple authorized users to participate in a media collaboration session for a given media object and obtain each authenticated user's security clearance. Authentication of a user may involve submission of a username and password, entry of biometric data, or the like. Upon successful authentication of the user, the media collaboration management application may determine whether the authenticated user has been designated as being an authorized participant with regard to the media object. If the authenticated user has been designated as an authorized participant as to the requested media object, then the authenticated user is granted access to the requested media object and may participate in the media collaboration session. In step 82, the media collaboration management application may identify the designated sub-elements of the media object and the classification level of each sub-element.

For each of the authorized users (i.e., 1 through n) identified in step 83, the media collaboration management application may redact any sub-elements of the media object having a designated security classification level that is greater than the security clearance level of the authorized user in step 84. Then, in step 85, the media collaboration management application may generate output of the media object with any redaction to the authorized user. Steps 84 and 85 are repeated until output has been generated for each of the authorized users, as determined in step 86. After output has been generated for each of the authorized users, then step 87 continues with the media collaboration session. Accordingly, each authorized user may participate in the collaboration session with respect to any sub-element that has not been redacted. Where each authorized user has been assigned a role in media collaboration session or with regard to the media object, then each authorized user's scope of interaction with the media object may be restricted accordingly.

Embodiments may beneficially allow users to collaborate on media without disclosing sensitive information to an authorized user that does not have a sufficient security clearance. Preferably, each authorized user participating in the media collaboration session only gains access to those sub-elements of the media object that have a classification level consistent with the authorized user's security clearance. Embodiments may obtain an authorized user's security clearance from a source outside the scope of the media collaboration application. In other words, the security clearance may be established and maintained by another system or third party tasked with assigning a security clearance to various individuals who may or may not ever participate in the media collaboration application. The security clearance of an individual may be used across various information systems to determine the individual's degree of access to sensitive information. By contrast, an individual user's role in a media collaboration session may be set by the media presenter without consideration for the individual's security clearance, and the individual user may be assigned differing roles across a number of media collaborations.

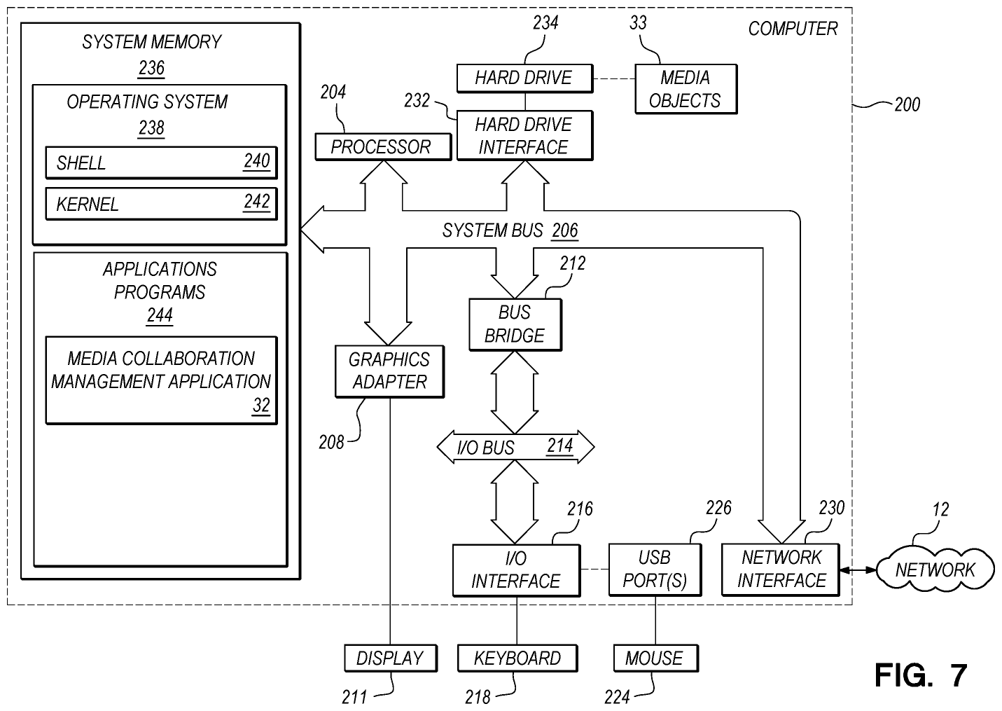

FIG. 7 is a diagram of a computer 200 that is representative of the application server 30 of FIGS. 1 and 2, and may also be representative of many hardware aspects of the client computers 20A-D of FIGS. 1 and 2. In the following description, the computer 200 will be described in the context of a server 30 running the media collaboration management application 32.

The computer 200 includes a processor unit 204 that is coupled to a system bus 206. The processor unit 204 may utilize one or more processors, each of which has one or more processor cores. A graphics adapter 208, which drives/supports the display 211, is also coupled to system bus 206. The graphics adapter 208 may, for example, include a graphics processing unit (GPU). The system bus 206 is coupled via a bus bridge 212 to an input/output (I/O) bus 214. An I/O interface 216 is coupled to the I/O bus 214. The I/O interface 216 may facilitate communication with various I/O devices, such as a keyboard 218 (such as a touch screen virtual keyboard) and a USB mouse 224 via USB port(s) 226 (or other type of pointing device, such as a trackpad). As depicted, the computer 200 is able to communicate with other network devices over the network 12 using a network adapter or network interface controller 230. For example, the computer 200 may communicate with one or more edge computers and one or more IoT devices or sensors.

A hard drive interface 232 is also coupled to the system bus 206. The hard drive interface 232 interfaces with a hard drive 234. In a preferred embodiment, the hard drive 234 communicates with system memory 236, which is also coupled to the system bus 206. System memory is defined as a lowest level of volatile memory in the computer 200. This volatile memory includes additional higher levels of volatile memory (not shown), including, but not limited to, cache memory, registers and buffers. Data that populates the system memory 236 includes the operating system (OS) 238 and application programs 244. Optionally, the hard drive 234 may store media objects 33. The hardware elements depicted in the computer 200 are not intended to be exhaustive, but rather are representative. For instance, the computer 200 may include non-volatile memory and the like.

The operating system 238 includes a shell 240 for providing transparent user access to resources such as application programs 244. Generally, the shell 240 is a program that provides an interpreter and an interface between the user and the operating system. More specifically, the shell 240 executes commands that are entered into a command line user interface or from a file. Thus, the shell 240, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while the shell 240 may be a text-based, line-oriented user interface, embodiments may support other user interface modes, such as graphical, voice, gestural, etc.

As depicted, the operating system 238 also includes the kernel 242, which includes lower levels of functionality for the operating system 238, including providing essential services required by other parts of the operating system 238 and application programs 244. Such essential services may include memory management, process and task management, disk management, and mouse and keyboard management. As shown, the computer 200 includes application programs 244 in the system memory of the computer 200, including, without limitation, the media collaboration management application 32.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising non-transitory computer readable storage media having program instructions embodied therewith, the program instructions executable by a processing unit to:
authenticate a plurality of users requesting access to a media object, wherein the media object includes a plurality of media sub-elements, each media sub-element delimiting specific content of the media object;
identify, for each of the plurality of sub-elements, a classification level associated with the media sub-element;
obtain, for each of the plurality of authenticated users, a security clearance; and
provide, for each of the authenticated users, output formed from the media object with redaction of each sub-element associated with a classification level that prevents access using the security clearance of the authenticated user.

2. The computer program product of claim 1, wherein the security clearance for each of the plurality of authenticated users is obtained from a secure remote node.

3. The computer program product of claim 1, wherein the program instructions are further executable by the processing unit to:
accept input from a media presenter, where the input identifies the media object, establishes a media collaboration session for the media object, designates one or more users that are authorized to participate in the media collaboration session, and assigns a role to each of the plurality of users.

4. The computer program product of claim 3, wherein the role assigned to each of the plurality of users is independently selected from:
a first role allowing the user to view, comment on, and edit sub-elements of the media object except for sub-elements that are subject to redaction for the user;
a second role allowing the user to view and comment on, but not edit, sub-elements of the media object except for sub-elements that are subject to redaction for the user; and
a third role allowing the user to view, but not comment on or edit, sub-elements of the media object except for sub-elements that are subject to redaction for the user.

5. The computer program product of claim 1, wherein each of the plurality of sub-elements is independently selected from a text element, an image, a video clip, an audio segment, and a hyperlink.

6. The computer program product of claim 1, wherein the plurality of sub-elements includes a plurality of text elements, wherein each text element is independently selected from a title, header, page, section, paragraph, sentence, name, address, number, caption, and footnote.

7. The computer program product of claim 1, wherein the security classification level that is assigned to each sub-element has a format selected from a classification number, a classification name, and an alphanumeric string of characters.

8. The computer program product of claim 1, wherein the program instructions executable by the processing unit to provide, for each of the authenticated users, output formed from the media object with redaction of each sub-element associated with a classification level that prevents access using the security clearance of the authenticated user, includes program instructions executable by the processing unit to provide, for each of the authenticated users, output formed from the media object excluding each sub-element associated with a classification level that prevents access using the security clearance of the authenticated user.

9. The computer program product of claim 1, wherein the program instructions executable by the processing unit to provide, for each of the authenticated users, output formed from the media object with redaction of each sub-element associated with a classification level that prevents access using the security clearance of the authenticated user, includes program instructions executable by the processing unit to provide, for each of the authenticated users, output formed from the media object with each sub-element associated with a classification level that prevents access using the security clearance of the authenticated user being obscured from view.

10. The computer program product of claim 1, wherein the program instructions are further executable by the processing unit to:
store, for each of the plurality of media sub-elements, the classification level that is associated with the media sub-element as metadata.

11. The computer program product of claim 1, wherein the program instructions are further executable by the processing unit to:
notify the media presenter that one or more of the authorized users do not have sufficient security clearance to view a particular sub-element of the media object.

12. The computer program product of claim 1, wherein the program instructions are further executable by the processing unit to:
automatically mute any audio signal to a given participant regarding the given sub-element
in response to the given participant having insufficient security clearance for the classification level of the sub-element.

13. A computer implemented method, comprising:
authenticating a plurality of users requesting access to a media object, wherein the media object includes a plurality of media sub-elements, each media sub-element delimiting specific content of the media object;
identifying, for each of the plurality of sub-elements, a classification level associated with the media sub-element;
obtaining, for each of the plurality of authenticated users, a security clearance; and
providing, for each of the authenticated users, output formed from the media object with redaction of each sub-element associated with a classification level that prevents access using the security clearance of the authenticated user.

14. The computer implemented method of claim 13, wherein each of the plurality of sub-elements is independently selected from a text element, an image, a video clip, an audio segment, and a hyperlink.

15. The computer implemented method of claim 13, wherein the program instructions executable by the processing unit to provide, for each of the authenticated users, output formed from the media object with redaction of each sub-element associated with a classification level that prevents access using the security clearance of the authenticated user, includes program instructions executable by the processing unit to provide, for each of the authenticated users, output formed from the media object excluding each sub-element associated with a classification level that prevents access using the security clearance of the authenticated user.

16. The computer implemented method of claim 13, wherein the program instructions executable by the processing unit to provide, for each of the authenticated users, output formed from the media object with redaction of each sub-element associated with a classification level that prevents access using the security clearance of the authenticated user, includes program instructions executable by the processing unit to provide, for each of the authenticated users, output formed from the media object with each sub-element associated with a classification level that prevents access using the security clearance of the authenticated user being obscured from view.

17. An apparatus, comprising:
at least one storage device for storing processor-executable program instructions; and
a processing unit including at least one processor for executing the program instructions to:
authenticate a plurality of users requesting access to a media object, wherein the media object includes a plurality of media sub-elements, each media sub-element delimiting specific content of the media object;
identify, for each of the plurality of sub-elements, a classification level associated with the media sub-element;
obtain, for each of the plurality of authenticated users, a security clearance; and
provide, for each of the authenticated users, output formed from the media object with redaction of each sub-element associated with a classification level that prevents access using the security clearance of the authenticated user.

18. The apparatus of claim 17, wherein each of the plurality of sub-elements is independently selected from a text element, an image, a video clip, an audio segment, and a hyperlink.

19. The apparatus of claim 17, wherein the program instructions executable by the processing unit to provide, for each of the authenticated users, output formed from the media object with redaction of each sub-element associated with a classification level that prevents access using the security clearance of the authenticated user, includes program instructions executable by the processing unit to provide, for each of the authenticated users, output formed from the media object excluding each sub-element associated with a classification level that prevents access using the security clearance of the authenticated user.

20. The apparatus of claim 17, wherein the program instructions executable by the processing unit to provide, for each of the authenticated users, output formed from the media object with redaction of each sub-element associated with a classification level that prevents access using the security clearance of the authenticated user, includes program instructions executable by the processing unit to provide, for each of the authenticated users, output formed from the media object with each sub-element associated with a classification level that prevents access using the security clearance of the authenticated user being obscured from view.
